(19) United States
(12) Patent Application Publication
(10) Pub. No.: US 2010/0062713 A1
(43) Pub. Date: Mar. 11, 2010

(54) HEADSET DISTRIBUTED PROCESSING

(76) Inventors: Peter John Blamey, Victoria (AU); Bonar Dickson, Victoria (AU); Anthony John Shilton, Victoria (AU)

Correspondence Address: CHRISTIE, PARKER & HALE, LLP, PO BOX 7068, PASADENA, CA, 91109-7068, US

(21) Appl. No.: 12/312,534

(22) PCT Filed: Nov. 13, 2007
(86) PCT No.: PCT/AU2007/001743

§ 371 Date: Aug. 31, 2009

(30) Foreign Application Priority Data
Nov. 13, 2006 (AU) 2006906326

(51) Int. Cl. H04B 7/00

(52) U.S. Cl. 455/41.3

(57) ABSTRACT

Distributing signal processing for a headset. The system comprises a headset and base device. The headset has one or more microphones, and one or more speakers. The headset communicates with the base device via a bidirectional wireless communications link such as Bluetooth. The headset has an on-board digital signal processor for processing at least one of electrical signals passing to the speaker and electrical signals passing from the microphone. The base device has a processor which can carry the burden of any or all processing functions which do not require short latency. And/or the base device's processor can control at least one aspect of digital signal processing of the digital signal processor of the headset, and effect such control via the wireless communications link.

### CROSS-REFERENCE TO RELATED APPLICATIONS

The present application claims priority from Australian Provisional Patent Application No 2006906326 filed on 13 Nov. 2006, the content of which is incorporated herein by reference.

### TECHNICAL FIELD

The present, invention relates to headsets and the like for telephony or audio applications, and in particular relates to the provision of off-board signal processing capabilities for such a headset.

### BACKGROUND OF THE INVENTION

A recent trend in head mounted devices such as headsets and earpieces for telephony, communications, and audio applications is towards a small battery-operated headset device which, via a wireless data connection, operates in conjunction with a nearby device such as a mobile or cellular telephone, a personal digital assistant (PDA), a personal computer (PC), a portable media player such as an iPod™, or the like. This arrangement is illustrated in FIG. 1. The data connection may be Bluetooth or WiFi, for example. Usually, the nearby device has some data processing capacity.

Because the headset is small and designed to be worn on the user's head it needs to be light with a minimum size battery. It also needs to have digital signal processing (DSP) capability to make up for the non-optimal acoustic properties implied by the small size, such as the relatively long distance between the microphone and the wearer's mouth which gives reduced (worse) signal-to-noise ratio compared to the more conventional headset with a boom microphone. The signal picked up by the microphone usually needs to be “cleaned” by processing with a suitable noise reduction algorithm. A further consequence of the small form factor of the headset is the proximity of the acoustic output speaker to the microphone. This gives rise to an acoustic echo when the output signal from the speaker is picked up by the microphone and re-transmitted back to the remote telephone user. Therefore suitable echo-cancellation signal processing should generally also be applied.

In conventional DSP enabled headsets, all such processing is done by a DSP chip in the headset itself. That is, all such processing is performed “on-board”.

However, the sophistication of digital signal processing and the number of different signal processing algorithms which can be carried out on-board is limited by the small battery size and the need for low power consumption. The low power consumption requirement also limits the number of microphones which can be used, generally preventing use of multi-microphone DSP techniques such as multi-microphone noise cancellation. Also, the small size of the headset imposes limits on the physical separation between the microphone and the speaker of the headset. These limitations make it difficult to implement sophisticated signal processing, especially noise reduction and feedback cancellation, amongst other DSP techniques.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY OF THE INVENTION

According to a first aspect the present invention provides a system for distributed signal processing for a headset, the system comprising:
a headset to be worn by a user, the headset having:
   at least one microphone for transducing acoustic sounds into electrical signals;
   at least one speaker for transducing electrical signals into acoustic sounds;
   a wireless communication transceiver for effecting a bidirectional wireless communications link with a base device; and
   a digital signal processor for processing at least one of electrical signals passing to the speaker and electrical signals passing from the microphone,
      and
a base device having:
   a wireless communication transceiver for effecting the wireless communications link with the headset; and
   a headset control module for controlling at least one aspect of digital signal processing of the digital signal processor of the headset, and for effecting such control via the wireless communications link.

According to a second aspect the present invention provides a headset enabled for distributed processing, the headset comprising:
at least one microphone for transducing acoustic sounds into electrical signals;
at least one speaker for transducing electrical signals into acoustic sounds;
a wireless communication transceiver for effecting a bidirectional wireless communications link with a base device; and
a digital signal processor for processing at least one of electrical signals passing to the speaker and electrical signals passing from the microphone, wherein at least one aspect of digital signal processing of the digital signal processor is controllable via the wireless communications link.

According to a third aspect the present invention provides a base device for providing distributed signal processing for a headset; the base device comprising:
a wireless communication transceiver for effecting a bidirectional wireless communications link with the headset; and
a headset control module for controlling at least one aspect of digital signal processing of a digital signal processor of the headset and for effecting such control via the wireless communications link.

According to a fourth aspect the present invention provides a method for providing distributed signal processing for a headset, the method comprising:
establishing a bidirectional wireless communications link between the headset and a base device; and
the base device controlling at least one aspect of digital signal processing of a digital signal processor of the headset via the wireless communications link.

The base device may be a desktop telephone, a mobile or cellular telephone, a personal digital assistant (PDA), a personal computer (PC), or a portable media player such as an iPod™ or MP3 player.

Embodiments of the present invention thus provide distributed processing for a telephony or audio headset, in which the headset communicates (probably wirelessly) with a nearby ‘base’ device. The base device could be provided with the capability to implement greater processing abilities to improve performance of the system comprising the headset and base, so that performance of the system is controlled by “distributed” processing. That is, the system operation is controlled in such embodiments by processing which is distributed between the headset and the base device. Alternatively, the base device might take on the burden of required signal processing functions, so that the headset DSP is not faced with the burden of such functions. For example, the headset might process the microphone signal by passing it through one or more filters, with the filter settings being determined by the base device which instructs the headset via the wireless communications link to change the filter settings at suitable times. In this arrangement, the DSP burden of determining appropriate filter settings is “off-board”, being in the nearby base device and not in the headset itself. Embodiments of the invention may provide such distributed processing without control signals, such that functionality is provided to the headset by processing carried out in the base. Alternative implementations may utilise unidirectional control signals whether from the base to the headset or from the headset to the base, or may utilise bidirectional control signals between the base and headset.

In preferred embodiments, the on-board headset processing is limited to aspects that need to be performed with short latency (such as side tone and acoustic echo cancellation) while the nearby base device provides other types of processing functions which are not so time-critical and may require greater processing capacity (such as transmit signal noise reduction, line echo cancellation, multi-band automatic gain and volume control). The nearby base device can also carry a microphone of its own for the particular purpose of measuring general background noise and providing noise cancellation, which will be much more effective because the “background noise” microphone is spaced substantially further away from the headset user's voice than is possible for microphones mounted on the headset itself.

In some embodiments of the invention, a single base device may provide distributed processing for a multiple-headset communications environment. For example, the base device may communicate wirelessly with multiple headsets for use in a conference call, or with multiple headsets used in the same acoustic environment, such as an open plan call centre. In such embodiments, the base device may exploit the presence of multiple microphones in order to improve environmental noise detection and cancellation, without the need for the base device itself to possess such a multiplicity of microphones. Furthermore, the base device is preferably operable to control one or more aspects of digital signal processing of each headset based on signal characteristics of one or more of the other headsets.

The headset may comprise any suitable sound piece, such as an external headset suitable for mounting on the pinna or an earpiece for placement partially or wholly within the auditory canal.

According to a further aspect the present invention provides a base device for providing distributed signal processing for a headset; the base device comprising:
a wireless communication transceiver for effecting a bidirectional wireless communications link with the headset; and
a signal processing module for carrying out signal processing functions not requiring short latency on at least one of signals received or transmitted over the wireless communications link and signals received form one or more microphones of the base device.

### BRIEF DESCRIPTION OF THE DRAWINGS

An example of the invention will now be described with reference to the accompanying drawings, in which:

FIG. 1 illustrates a headset and base device connected by a wireless communications link;

FIGS. 2a and 2b illustrate example signal processing capabilities provided by a headset, of which one or more of such capabilities may be moved off-board in accordance with an embodiment of the invention;

FIG. 3 illustrates elements of a telephony signal processing system which may be distributed between a base device and headset;

FIGS. 4a and 4b illustrate the signal processing elements of each of the base device and headset in accordance with one embodiment of the present invention;

FIG. 5 illustrates a system configuration for a small headset for mobile or cellular telephony;

FIG. 5 illustrates a system configuration for distributed processing for stereo headphones for music playback devices; and

FIG. 7 illustrates a general-purpose computing device that may be used in an exemplary system for implementing the invention;

### DESCRIPTION OF THE PREFERRED EMBODIMENTS

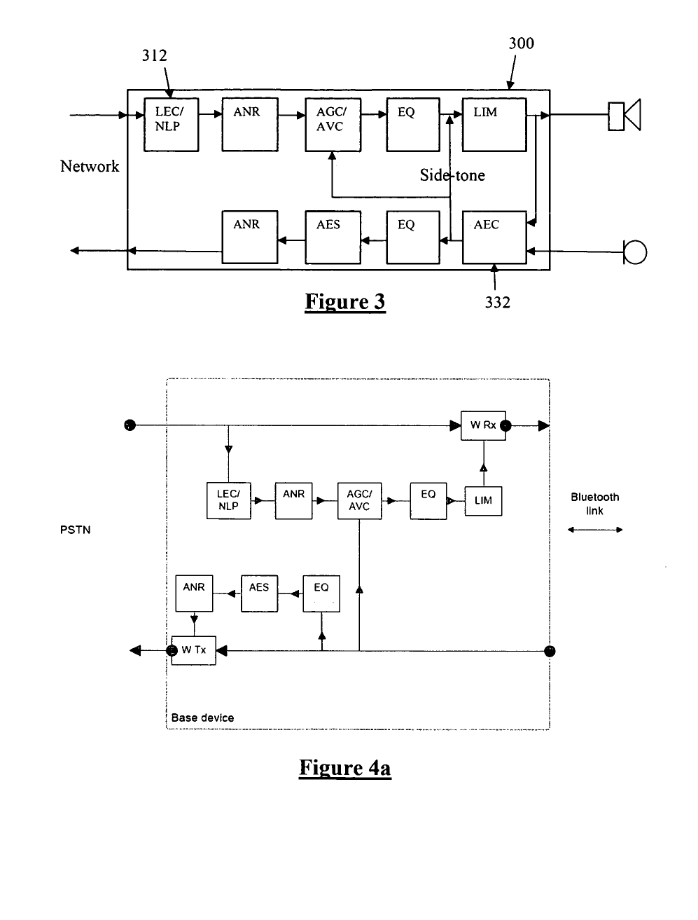

FIGS. 2a and 2b illustrate a number of desirable DSP functions for an example state-of-the-art headset application. Receive signal processing includes frequency equalization 210 to compensate for output transducer characteristics, automatic gain control 212 to compensate for variability in the received signal level, automatic volume control 212 to compensate for variable ambient noise in the listener's environment, noise reduction 214 or noise cancellation to improve sound quality of the received signal, and line echo cancellation. Transmit signal processing includes frequency equalization 222 to compensate for microphone characteristics, automatic gain control 212 to compensate for variability in speaking level and variability in the microphone position and alignment with the speaker's mouth, noise reduction 226 to remove ambient noise from the transmitted signal, acoustic echo cancellation 224, multiple-microphone noise reduction, and side-tone 228 with howling suppression (acoustic feedback cancellation). FIG. 2b shows a similar system to FIG. 2a, in which the headset instead comprises two microphones. The VoiceField function block is the directional microphone noise cancellation system for the transmitted signal. The BreezeGuard block provides a two-microphone wind noise reduction algorithm.

Preferably, in accordance with the invention the portion of the processing carried out in the headset is minimized, so as to provide maximum battery life and minimum headset size. Nevertheless, some elements of the DSP processing generally should be located in the headset itself because of the short time latency required to make the processing effective. Examples of such on-board processing include side-tone with howling suppression 228, and two-microphone noise reduction using a beam-former directional microphone approach. However, much of the remaining types of processing could be done off-board in the nearby base device, which usually has a larger battery and/or mains power supply and a greater processing capacity than the headset DSP chip.

The base device preferably controls the operation of the DSP of the headset by way of a control data stream established over the wireless communications link. The control data stream may be interleaved with the audio data stream in the wireless link. The headset may also control aspects of the digital signal processing in the base device and/or communicate operational parameters to the base device using the same bidirectional wireless link using data interleaved with the audio stream. An advantage of interleaving such control data with audio signals is that it maintains timing of the control data relative to the audio signals despite potentially unknown or variable delays inherent in the wireless link.

The system could include more than one headset, for example for conference calls. The headsets could all share the processing in the single nearby base device. Each headset thus contributes an additional microphone signal for the noise reduction in the transmitted signal, with the noise reduction processing performed by the base device. This will add to the effectiveness of the processing, with additional cost and power savings.

Thus, this invention splits DSP processing between the headset and the nearby base device to achieve a “distributed processing” solution to the problem.

Advantages of distributed processing for wireless headsets include:
1. Increased battery life for the headset component because the processing load is reduced.
2. Smaller headset size because the DSP chip and the battery can be smaller.
3. Improved sound quality because the greater processing power of the nearby device can be used to implement more sophisticated, more effective algorithms.
4. Improved sound quality because the nearby device can also have one or more microphones and/or may take into account noise conditions present at other headsets with which the base device is in communication. These microphones will be more remote from the headset wearer's mouth and will therefore pick up more noise and less speech. This is an advantage for multi-microphone noise reduction which requires good separation between the speech and the noise.

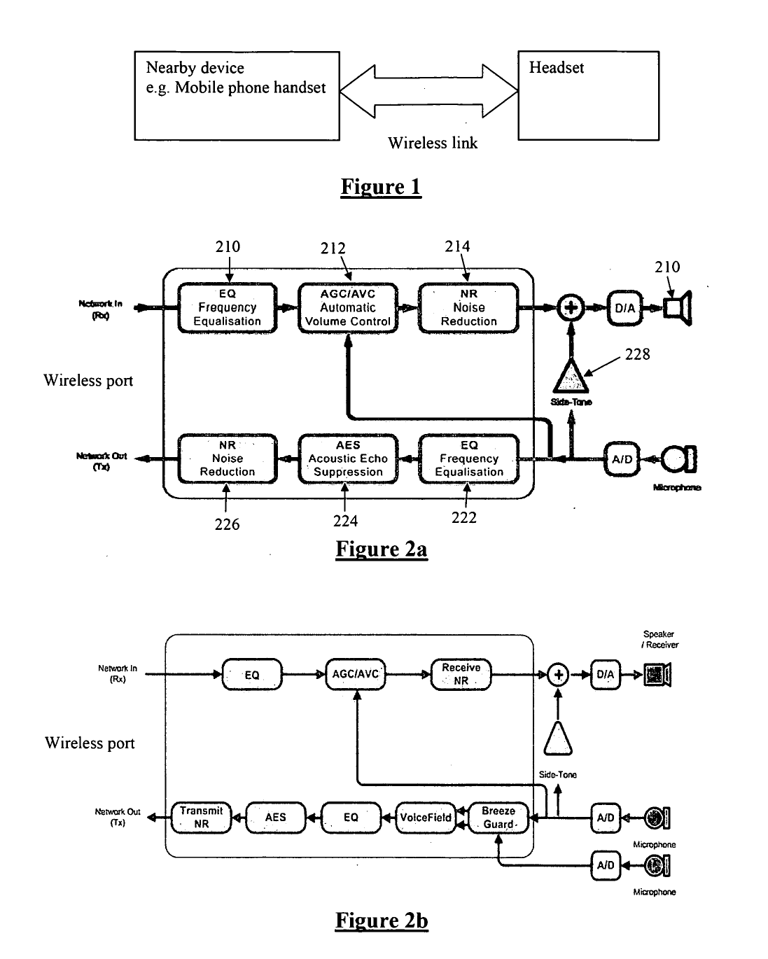

A particular example of such distributed processing is now described in relation to a Bluetooth headset and base, with reference to FIG. 3. The base is an interface to a communications network such as PSTN or internet protocol telephony or audio system (often through connection to a host telephone), and is paired with the Bluetooth headset. The same Bluetooth headset may be paired at other times to a mobile phone or other Bluetooth device. FIG. 1 shows a typical combination of headset and base. There may be more than one microphone, and stereo headsets have two speakers.

In addition to the issues set out above in relation to FIG. 2, there are some particular characteristics of the headset/base system of FIG. 3. The network (or host phone) often has echo, whereby some of the signal transmitted into the network returns in the received signal. A line echo canceller 312 is used to remove this echo. The delay in the Bluetooth link between headset and base may be as high as 20 ms in each direction.

When becoming paired with a headset by establishment of a Bluetooth link, the base device interrogates the headset to find out what model it is. The base device then ensures that processing it carries out on behalf of that headset can be adapted to meet that headset's specific configurations, performance characteristics, and the like. The base device is thus preferably equipped with, or connected to, a library of device-specific information for a plurality of devices with which it is anticipated the base device may become paired.

The headset often has acoustic echo, that is, some of the sound output from the speaker is picked up by the microphone. An acoustic echo canceller 332 is used to remove this echo. The total delay in an echo path and the level of the echo signal contribute to how it is perceived by the user. For a long delay a low level of echo will be more evident to the user than with a shorter delay but the same level. A general design goal is to keep the system delay as low as possible.

The typical software functions of the system 300 are shown in FIG. 3. Note that in FIG. 3 the functions performed within system 300 may be provided by either the base device or by the headset, with the Bluetooth link not being shown in FIG. 3. The order in which the various functions are performed may also vary.

### ANR=Adaptive Noise Reduction

### LEC=Line Echo Canceller

NLP=Non-linear processing (removes residual echo)

### AGC=Automatic Gain Control

### AVC=Automatic Volume Control

### EQ=Equalisation

### LIM=Limiting

### AEC=Acoustic Echo Cancellation

### AES=Acoustic Echo Suppression

The ADRO technique set out in U.S. Pat. No. 6,731,767, the content of which is incorporated herein by reference, may be used in place of the EQ, AVC and AGC on receive and in place of basic EQ in transmit. NLP, ANR, AGC, AVC, EQ and LIM on receive are implemented as “off-line processing” using a single on-line adaptive filter which is controlled by appropriate off-line processing to effect these functions.

EQ, AES and ANR on transmit are often implemented as “off-line processing” using a single adaptive filter. Many of the functions rely on having knowledge of the receiver and microphone response (a calibration) to function correctly. Therefore, if they are performed in the base it is important that the base knows what model headset is connected.

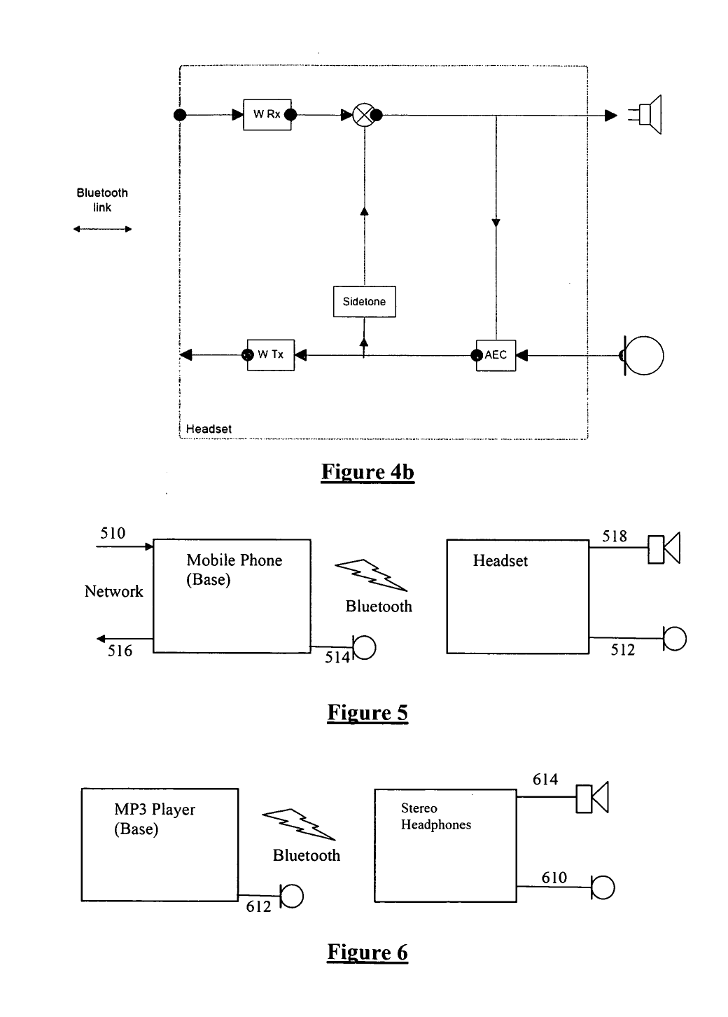

One configuration, shown in FIG. 4a, is to place the LEC, NLP, ANR, AGC, AVC, EQ and LIM on receive in the base and the ANR, AES and EQ on transmit in the base. The AEC would be placed in the headset, as shown in FIG. 4b. The advantage of this is that all receive processing can be performed using two filters (one for LEC, one for off-line processing) and transmit processing also only requires two filters (one for AEC, one for off-line processing). For example each off-line filter may be provided in accordance with techniques set out in International Patent Publication No. WO 2007/095664, the content of which is incorporated herein by reference. The processing in the headset is kept to a minimum, thus preserving the battery life and talk time.

FIG. 4b further shows two adaptive filters in the headset, one in each of the receive path and transmit path. Filter tap settings for the filters of the headset may be computed by the base device of FIG. 4a and communicated to the headset of FIG. 4b via the wireless link, for example using a dedicated headset control channel of the link.

At times when the headset is paired with a mobile phone, all processing is transferred back to the headset. That is, in this embodiment the processing distribution is re-configured as the system configuration changes.

Headset distributed processing thus provides a means for simultaneously optimizing sound quality and minimizing power consumption in a headset or similar listening device.

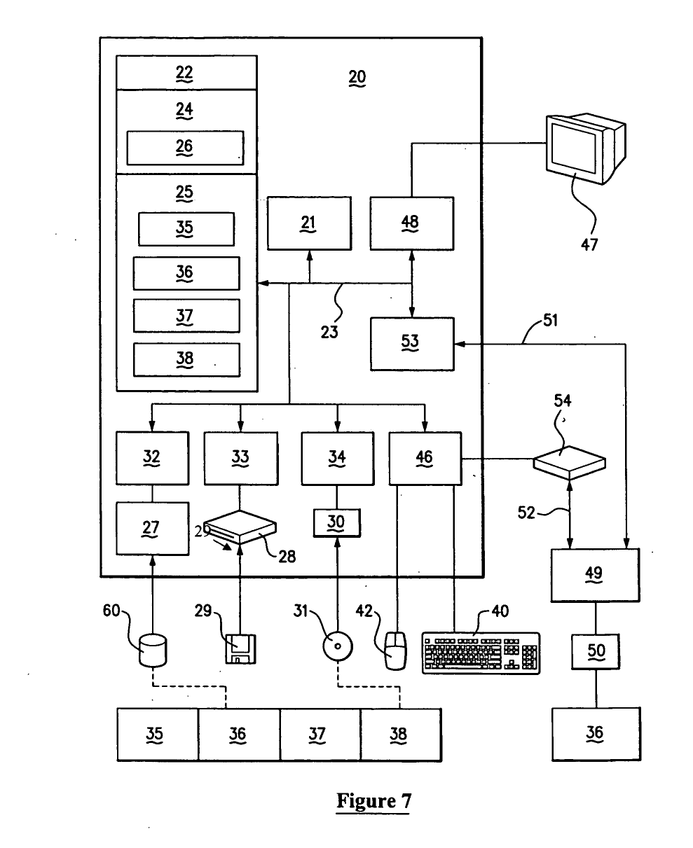

A further embodiment relating to an ultra-small headset for mobile telephony is now described with reference to FIG. 5. This embodiment recognises the increased need for a hearing aid sized monaural headset for use with a mobile phone. Low processing power is very important because of limited space in the ear canal for the battery, and the scope for placing multiple microphones outside the ear will also be severely limited.

In the embodiment of FIG. 5, the input signals arise from the received telephone signal 510, from microphones 512 which will be either one or two microphones on the headset and positioned either inside or immediately outside the ear canal, and from one or more microphones 514 placed on the mobile phone.

Outputs of the system of FIG. 5 comprise the transmitted telephone signal 516 intended for a remote listener, and the output signal 518 played through the headset speaker and including side tone and the received signal.

Sound sources in the acoustic environment of the headset wearer include the user's voice, noise whether environmental, music, other voices, wind, etc, and the output signal as played through the headset speaker including side tone and received signal. The signal processing goals are to optimize the headset user's voice and minimize other sound sources so as to maximise quality of the transmitted telephone signal 516, to optimize intelligibility of the received signal 510 when played out as signal 518, and to output a signal to cancel low-frequency environmental sounds for enhanced received intelligibility and comfort in noise. This will be more important for headsets that offer minimal occlusion.

In the embodiment of FIG. 5, the signal processing would once again be split between the headset and the mobile phone which acts as the base device, with the division of processing being decided following similar principles to those discussed in the preceding. That is, acoustic echo reduction and cancellation, side tone production, active noise cancellation for the local listener, and directional microphone processing all require very low processing delay and are ideally located in the headset to avoid incurring the longer delay in the Bluetooth wireless link. Transmit noise reduction and cancellation, line echo cancellation, receive and transmit equalization to maximize intelligibility and sound quality for both local and remote listeners, automatic gain and volume control depending on received signal amplitude and ambient noise level respectively, can all tolerate longer time delays and can therefore be placed in the mobile phone where a larger battery is available. Removal of the latter processing load from the headset provides longer battery life and thus longer talk time for the user between battery recharges, and/or enables use of a smaller battery permitting a smaller form factor for the headset. Moreover, the additional microphone input 514 on the mobile phone can be used to obtain a reference noise signal that contains little of the headset user's voice signal, simplifying the process of separating voice from noise, voice activation detection, and other parts of the signal processing to provide improved sound quality.

The Bluetooth link is used to convey control signals between the headset and mobile phone in addition to the bidirectional transmitted and received voice signals. The control link from the headset to the phone can be used to identify the type of headset and provide information about the microphone and speaker characteristics of the headset for the equalization, AGC, and AVC processing in the mobile phone handset. The control link from the base to the headset could provide control of analog amplification in the headset and other functions such as power off at the end of a call.

More sophisticated applications could include speech synthesis and recognition in the base device to produce a completely hands-free voice activated system which may be impossible with the more limited processing capacity available in the miniature headset processor. In this case, the use of the microphones and signal processing in the headset would provide a cleaner voice signal than is available from the microphone on the mobile handset, enhancing the overall performance of the speech recognition.

A further embodiment relating to stereo headphones for music is now described with reference to FIG. 6. This embodiment recognises the increasing need for headphones for MP3 players and the like. New mobile or cellular telephones are also increasingly likely to support music downloads, video downloads and gaming. Flexibility of design to achieve stylish and comfortable products must be supported by strong signal processing, and it is preferred to avoid the use of a microphone boom on such products.

In the embodiment of FIG. 6 the signal inputs include signals from microphones 610, which could comprise two or more microphones possibly placed within as well as outside the ear canal and possibly one or more on each ear. The signal inputs also include signals 612 from a microphone placed on the MP3 player, which is serving as the base device in the distributed processing system configuration of the present embodiment of the invention. Outputs of the system of FIG. 6 include stereo playback signal 614, which is primarily music in this embodiment. Sound sources in the acoustic environment include noise such as environmental, music, other voices, wind, etc, and also include the stereo signal 614 as played out through the speakers.

The embodiment of FIG. 6 further provides for signal processing, distributed between the MP3 player and the headphones, with the goals of providing automatic control of output level for stereo signal, and outputting a signal to cancel environmental noise.

The system of FIG. 6 can thus be thought of as a simplified version of the headset for mobile telephony described above in relation to FIG. 5. By incorporating distributed processing, active noise cancellation can be incorporated in the headphones while the automatic volume control, equalization, sound pressure level monitoring, and hearing protection data processing burden can be incorporated into the MP3 player base device. For sound level monitoring and hearing protection applications the base device needs data from the headset indicating output levels and ambient noise levels at the ear, which can simply be transmitted by the headphones over the Bluetooth link.

The advantages of the distributed processing over a wireless system with a single processor in the headset are the possibility of a smaller form factor and longer battery life. The advantages of the distributed processing over a wireless system with a single processor in the base are higher sound quality because of the active noise cancellation which requires low delay, more accurate sound level monitoring and more effective hearing protection because of the proximity of the microphone to the ear.

A further embodiment relating to teleconferencing system with multiple headsets is now described. This embodiment provides for a single mains powered base device that communicates via a wireless link with two or more headsets. The base device has access to the signals picked up by microphones on all the headsets. As for the examples discussed in the preceding, headset size can be smaller, power consumption can be lower, and the cost of production can be lower for the individual headsets because a large part of the processing is done in the base device. Using multiple headsets, each with its own processing, can improve sound quality for the individual headset users by providing more effective echo cancellation, side tone, active noise cancellation, and control of the level of the received signal. Using multiple headsets also increases sound quality for the remote listeners through improved signal pick-up from the microphones on the headsets and improved noise reduction in the base device using all of the available information from the individual headset microphones.

Some portions of this detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

As such, it will be understood that such acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data is maintained are physical locations of the memory that have particular properties defined by the format of the data. However, while the invention is described in the foregoing context, it is not meant to be limiting as those of skill in the art will appreciate that various of the acts and operations described may also be implemented in hardware.

It should be borne in mind, however, that all of these and similar terms are to be associated with the appropriate physical quantities and are merely convenient labels applied to these quantities. Unless specifically stated otherwise as apparent from the description, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

Turning to FIG. 7, the invention is illustrated as being implemented in a suitable computing environment where the computer may perform all or part of the signal processing as the base device. Although not required, the invention will be described in the general context of computer-executable instructions, such as program modules, being executed by a personal computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multi-processor systems, microprocessor-based or programmable consumer electronics, network PCs, minicomputers, mainframe computers, and the like. The invention may be practiced in distributed computing environments where tasks are performed by remote processing devices that are linked through a communications network. In a distributed computing environment, program modules may be located in both local and remote memory storage devices.

In FIG. 7 a general purpose computing device is shown in the form of a conventional personal computer 20, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system (BIOS) 26, containing the basic routines that help to transfer information between elements within the personal computer 20, such as during start-up, is stored in ROM 24. The personal computer 20 further includes a hard disk drive 27 for reading from and writing to a hard disk 60, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer readable instructions, data structures, program modules and other data for the personal computer 20. Although the exemplary environment shown employs a hard disk 60, a removable magnetic disk 29, and a removable optical disk 31, it will be appreciated by those skilled in the art that other types of computer readable media which can store data that is accessible by a computer, such as magnetic cassettes, flash memory cards, digital video disks, Bernoulli cartridges, random access memories, read only memories, storage area networks, and the like may also be used in the exemplary operating environment.

A number of program modules may be stored on the hard disk 60, magnetic disk 29, optical disk 31, ROM 24 or RAM 25, including an operating system 35, one or more applications programs 36, other program modules 37, and program data 38. A user may enter commands and information into the personal computer 20 through input devices such as a keyboard 40 and a pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port or a universal serial bus (USB) or a network interface card. A monitor 47 or other type of display device is also connected to the system bus 23 via an interface, such as a video adapter 48. In addition to the monitor, personal computers typically include other peripheral output devices, not shown, such as microphones, speakers and printers.

The personal computer 20 may operate in a networked environment using logical connections to one or more remote computers, such as a remote computer 49. The remote computer 49 may be another personal computer, a server, a router, a network PC, a peer device or other common network node, and typically includes many or all of the elements described above relative to the personal computer 20, although only a memory storage device 50 has been illustrated. The logical connections depicted include a local area network (LAN) 51 and a wide area network (WAN) 52. Such networking environments are commonplace in offices, enterprise-wide computer networks, intranets and, inter alia, the Internet.

When used in a LAN networking environment, the personal computer 20 is connected to the local network 51 through a network interface or adapter 53. When used in a WAN networking environment, the personal computer 20 typically includes a modem 54 or other means for establishing communications over the WAN 52. The modem 54, which may be internal or external, is connected to the system bus 23 via the serial port interface 46. In a networked environment, program modules depicted relative to the personal computer 20, or portions thereof, may be stored in the remote memory storage device. It will be appreciated that the network connections shown are exemplary and other means of establishing a communications link between the computers may be used.

It will be appreciated by persons skilled in the art that numerous variations and/or modifications may be made to the invention as shown in the specific embodiments without departing from the scope of the invention as broadly described. The present embodiments are, therefore, to be considered in all respects as illustrative and not restrictive.

1. A system for distributed signal processing for a headset, the system comprising:
a headset to be worn by a user, the headset having:
at least one microphone for transducing acoustic sounds into electrical signals;
at least one speaker for transducing electrical signals into acoustic sounds;
a wireless communication transceiver for effecting a bidirectional wireless communications link with a base device; and
a digital signal processor for processing at least one of electrical signals passing to the speaker and electrical signals passing from the microphone,
and
a base device having:
a wireless communication transceiver for effecting the wireless communications link with the headset; and
a headset control module for controlling at least one aspect of digital signal processing of the digital signal processor of the headset, and for effecting such control via the wireless communications link.

2. The system of claim 1 wherein the processor of the headset performs tasks that need short latency, and wherein the headset control module of the base device performs all tasks not requiring short latency.

3. The system of claim 2 wherein the processor of the headset provides at least one of side tone, directional microphone functionality, wind noise reduction, and acoustic echo cancellation, and wherein the headset control module of the base device performs at least one of equalisation, transmit signal noise reduction, line echo cancellation, multi-band automatic gain and volume control.

4. The system of claim 1 wherein the base device is a least one of: a desktop telephone; a mobile or cellular telephone; a personal digital assistant (PDA); a personal computer (PC); and a portable media player.

5. The system of claim 1 wherein the headset processes the microphone signal by passing it through at least one adaptive filter, and wherein the filter settings are determined by the base device which instructs the headset via the wireless communications link to change the filter settings at suitable times.

6. The system of claim 1 wherein the base device comprises a microphone, and wherein the headset control module is operable to use signals from the base device microphone to provide at least one of noise cancellation and voice activity detection.

7. The system of claim 1 wherein the base device is operable to provide distributed processing for a plurality of headsets.

8. The system of claim 7 wherein the base device uses signal information and/or control signals from the plurality of headsets for environmental noise cancellation.

9. The system of claim 7 wherein the base device is operable to control one or more aspects of operation of each headset based on at least one of: signal characteristics of one or more of the other headsets; and control signals from one or more of the other headsets.

10. (canceled)

11. (canceled)

12. (canceled)

13. (canceled)

14. A base device for providing distributed signal processing for a headset; the base device comprising:
a wireless communication transceiver for effecting a bidirectional wireless communications link with the headset; and
a headset control module for controlling at least one aspect of digital signal processing of a digital signal processor of the headset and for effecting such control via the wireless communications link.

15. The base device of claim 14 wherein the headset control module performs signal processing tasks not requiring short latency.

16. The base device of claim 15 wherein the headset control module performs at least one of transmit signal noise reduction, line echo cancellation, multi-band automatic gain and volume control.

17. The base device of claim 14 wherein the base device is a least one of: a desktop telephone; a mobile or cellular telephone; a personal digital assistant (PDA); a personal computer (PC); and a portable media player.

18. The base device of claim 14 wherein the base device is operable to determine appropriate filter settings of an adaptive filter of the headset and is operable to instruct the headset via the wireless communications link to update the filter settings at suitable times.

19. The base device of claim 14 further comprising a microphone, and wherein the headset control module is operable to use signals from the base device microphone to provide at least one of noise cancellation and voice activity detection.

20. The base device of claim 14 wherein the base device is operable to provide distributed processing for a plurality of headsets.

21. The base device of claim 20 wherein the base device uses signal information from the plurality of headsets for environmental noise reduction.

22. The base device of claim 20 wherein the base device is operable to control one or more aspects of operation of each headset based on at least one of: signal characteristics of one or more of the other headsets; and control signal from one or more of the other headsets.

23. A method for providing distributed signal processing for a headset, the method comprising:
establishing a bidirectional wireless communications link between the headset and a base device; and
the base device controlling at least one aspect of digital signal processing of a digital signal processor of the headset via the wireless communications link.
